(19) United States
(12) Patent Application Publication
(10) Pub. No.: US 2026/0200314 A1
(43) Pub. Date: Jul. 16, 2026

(54) ASSEMBLY COMPRISING A BLADDER FOR A FUEL TANK

(71) Applicant: OPMOBILITY C-POWER BELGIUM RESEARCH, Woluwe-Saint-Lambert (BE)

(72) Inventors: Dominique MADOUX, Bruxelles (BE); Pierre OSZWALD, Bruxelles (BE)

(73) Assignee: OPMOBILITY C-POWER BELGIUM RESEARCH, Woluwe-Saint-Lambert (BE)

(21) Appl. No.: 19/136,099

(22) PCT Filed: Dec. 8, 2023
(86) PCT No.: PCT/EP2023/084832

§ 371 Date: Jun. 5, 2025

(30) Foreign Application Priority Data
Dec. 9, 2022 (BE) BE20226005

(51) Int. Cl. B60K 15/077; B60K 15/035

(52) U.S. Cl. CPC B60K 15/077; B60K 15/03519; B60K 2015/0775

(57) ABSTRACT

An assembly includes a bladder for a fuel tank. The bladder has a first configuration in which the bladder is wound in on itself so as to confer thereon a first geometric shape which has a first volume. The bladder has a second configuration in which the bladder is unwound so as to confer thereon a second geometric shape which has a second volume. The first volume is strictly smaller than the second volume. The assembly also has an attachment device to attach the assembly to a fuel tank inner wall.

### TECHNICAL FIELD OF THE INVENTION

The present invention relates generally to the control of fuel vapor pressure in a fuel tank of a fuel storage system for a heat engine (also called internal combustion engine) vehicle, in particular a motor vehicle. “Motor vehicle” refers to any mobile equipment, in particular vehicles on roads, rails, sea, air, space.

More particularly, the invention concerns an assembly comprising a bladder for a fuel tank for a heat engine vehicle.

The invention also concerns an assembly according to the invention comprising a removable retaining device.

The invention also concerns an assembly according to the invention comprising an anti-slosh device.

The invention also relates to a fuel storage system for a heat engine vehicle comprising a fuel tank and at least one assembly in accordance with the invention.

The invention also relates to the use of at least one assembly according to the invention in a fuel tank of a fuel storage system for a heat engine vehicle.

The invention also concerns a kit for manufacturing a fuel storage system for a heat engine vehicle comprising an anti-slosh device and at least one assembly according to the invention.

The invention also relates to a heat engine vehicle, in particular a motor vehicle, comprising a fuel storage system according to the invention. The invention has a particular application for hybrid vehicles. Hybrid vehicles are vehicles equipped with a combustion engine combined with one or more electric motors.

The invention also relates to a method of manufacturing a fuel storage system for a heat engine vehicle comprising a fuel tank and at least one assembly in accordance with the invention.

The invention also relates to a fuel storage system for heat engine vehicles obtained by implementing the manufacturing process according to the invention.

Finally, the invention relates to a method of operating a fuel storage system according to the invention.

The fuel stored in a fuel tank of a fuel storage system for a heat engine vehicle is subject to temperature fluctuations that depend mainly on the outside temperature. Depending on the climate to which the vehicle is exposed, fuel temperature can vary greatly, especially if the vehicle is outdoors when driving or parked. When the temperature of the fuel stored in the fuel tank rises, some of it evaporates. As the fuel tank defines a predetermined volume, closed and sealed, the generation of fuel vapors leads to a rise in pressure in the gaseous phase inside the fuel tank. High fuel pressure of vapors generates mechanical stresses on the fuel tank walls, which can damage them or at the very least constitute a risk of fuel tank explosion if the pressure rise is not controlled.

### TECHNICAL BACKGROUND OF THE INVENTION

It is known in the prior art, for example from document WO 2021/013940 A1, to place an inflatable bladder inside the fuel tank. This bladder is connected to an air inlet and outlet pipe leading from the fuel tank, enabling air to be alternately supplied to the bladder or discharged from it. In this way, depending on the fluctuation in the amount of fuel vapor in the tank, the bladder can inflate or deflate to modify the volume available for fuel vapor and thus limit variations in fuel vapor pressure.

Although this bladder system reduces the risk of pressure peaks in the fuel tank, it does pose certain problems. Indeed, the relatively large volume of the bladder may be incompatible with the generally complex shape of the fuel tank or, conversely, may necessitate modifying the shape of the fuel tank so that it has an area of shape and dimensions to accommodate the bladder. For example, for a 45-liter fuel tank, the bladder needs to have a volume of around 20 liters to have a significant beneficial effect, which necessitates a large enough and clear area inside the tank to receive the bladder. In addition, the large volume of the bladder makes it complex to insert into the fuel tank and to attach while the fuel tank is being manufactured, which in turn increases the cost and time required to manufacture the fuel tank.

### SUMMARY OF THE INVENTION

In particular, the invention aims to solve the problems identified in the prior art by limiting the pressure build-up of fuel vapors in the fuel tank and avoiding or mitigating the disadvantages posed by the prior art bladder and its large volume.

To this end, the invention has as its object an assembly according to a first embodiment comprising a bladder for a fuel tank, characterized in that the bladder is configured to have:
a first configuration wherein the bladder is wound in on itself, preferably about an axis X, so as to confer thereon a first geometric shape which has a first volume, and
a second configuration wherein the bladder is unwound, preferably around the X axis, so as to confer thereon a second geometric shape which has a second volume,
the first volume being strictly smaller than the second volume,
the assembly further comprising an attachment device configured to attach the assembly to a fuel tank inner wall.

Thus, the bulky bladder of the prior art is here replaced by a bladder having a reduced volume during its insertion and attachment in a fuel tank. This facilitates the insertion of the bladder inside a fuel tank through an opening in a fuel tank wall, for example, a fuel tank bung hole. Furthermore, thanks to the attachment device, the bladder does not unwind just anywhere in the fuel tank but in a predetermined space therein, a space that did not require the fuel tank's shape be altered to accommodate the bladder. The predetermined space is chosen so that the bladder unwinds unhindered in the fuel tank and, in the second configuration, does not interfere with the interior of the fuel tank, which could damage the bladder. The bung hole is used to insert one or more fuel tank components into the fuel tank, e.g., a fuel pump to be installed at the bottom of the fuel tank. After installation of the fuel tank internal component(s) and before putting the fuel tank into service, the bung hole is hermetically sealed. In one example, the bung hole has a diameter of 130 mm.

Advantageously, the bladder is manufactured unwound, that is, in its initial shape. Even more advantageously, the bladder is made of an elastic material, that is, a flexible, deformable material that returns to its initial shape when it is no longer mechanically stressed. This makes the bladder “windable”. The “windable” character of the bladder corresponds to its ability to move from an unwound to a wound configuration, and vice versa, without undergoing major plastic deformation, like a rollable mattress. In one example, the bladder is manufactured from a thermoplastic elastomer material, such as thermoplastic polyurethane (TPU). Thanks to this feature, the bladder is not only deformable when unwound, it is also deformable when wound in on itself, for example, in the first configuration, the bladder is still deformable in torsion and/or flexion.

Advantageously, the bladder is made of polyethylene (PE), polyamide (PA), or in the form of a multilayer material comprising polyethylene (PE), preferentially high-density polyethylene (HDPE), and ethylene vinyl alcohol (EVOH).

Preferentially, the polyethylene is high-density polyethylene (HDPE), and the polyamide is polyamide 6, 11 or 12 (PA6, PA11 or PA12).

Advantageously, the multilayer comprises an adhesive layer between the polyethylene (PE) layer, preferentially high-density polyethylene (HDPE), and the ethylene vinyl alcohol (EVOH) layer.

In this way, different materials can be chosen for the bladders to give them a choice of characteristics, such as low cost, mechanical strength or fuel impermeability.

In addition, the fact that the bladder is wound in on itself in a first configuration means that the bladder can be inserted into the fuel tank after the fuel tank has been manufactured and not necessarily during fuel tank manufacture, thus simplifying the fuel tank production pipe.

Preferably, the first geometric shape is generally cylindrical.

Preferably, the second geometric shape is generally prismatic, cylindrical or spherical.

The second volume is proportional to the volume of fuel in the fuel tank. Advantageously, the second volume is between 20% and 50% of the volume of fuel wherein the bladder is immersed, preferentially the second volume is between 20% and 30% of the volume of fuel wherein the bladder is immersed.

This makes it easy to size the bladder according to the specifications to be met by the fuel tank. In other words, the shape and volume of the bladder can be easily adapted to take into account the architecture of the fuel tank, showing the versatility of the invention.

By “fuel” we mean a hydrocarbon suitable for powering internal combustion engines. For particular engines, the fuel can be based on alcohol, for example, ethanol, bioethanol, butanol, methanol, their mixtures, for example with hydrocarbons.

“Tank” is understood to mean a sealed container able to store a fuel under diverse and varied conditions of use and environments. The tank according to the invention comprises a wall, also known as a shell, delimiting a hollow body. A tank wall comprises an inner wall and an outer wall. The inner wall faces the interior volume of the hollow body, while the outer wall faces the volume outside the hollow body. The hollow body according to the invention is made of metal or plastic, preferably plastic. In the latter case, it comprises at least one synthetic resin polymer in the solid state under ambient conditions. Plastic hollow bodies are preferred for their greater elasticity and superior ability to be shaped into complex shapes.

A hollow plastic body can be produced by any known processing method. A known embodiment is the injection method. Extrusion blow-molding and rotational molding processes are also well known.

By “plastic material” we mean both the generally homogeneous material of a single-layer structure and the heterogeneous material of a multi-layer structure.

The hollow body advantageously comprises at least one thermoplastic polymer, that is, a polymer which melts or softens sufficiently under the influence of heat to enable it to be shaped.

The term “polymer” refers to both homopolymers and copolymers (in particular binary or ternary). Examples of such copolymers are, in a non-limiting manner: random copolymers, block copolymers, block copolymers and grafted copolymers.

Any type of thermoplastic polymer or copolymer whose melting point is lower than the decomposition temperature is suitable. Thermoplastic polymers which have a melting range spread over at least 10 degrees Celsius (10° C.) are particularly suitable. Examples of such materials are those which exhibit a polydispersion of their molecular mass.

In particular, it is possible to use polyolefins, thermoplastic polyesters, polyketones, polyamides and copolymers thereof. A mixture of polymers or copolymers may also be used, as well as a mixture of polymeric materials with inorganic, organic and/or natural fillers such as, for example, but not limited to carbon, salts and other inorganic derivatives, natural or polymeric fibers. It is also possible to use multilayer structures consisting of stacked and integral layers comprising at least one of the aforementioned polymers or copolymers.

A polymer often employed is polyethylene. Excellent results were obtained with high-density polyethylene (HDPE).

In one example, the hollow body comprises a multilayer structure comprising at least one layer of thermoplastic material and at least one additional layer which can advantageously consist of a liquid and/or gas barrier material. Preferably, the nature and the thickness of the barrier layer are chosen so as to limit as much as possible the permeability of the liquids and of the gases in contact with the wall of the tank. Preferably, this layer is based on a barrier material, that is to say a resin impermeable to a fuel such as EVOH, for example (ethylene copolymer—partially hydrolyzed vinyl acetate). Alternatively, the hollow body may be subjected to a surface treatment (fluorination or sulfonation), the purpose of which is to make it impermeable to the fuel.

Advantageously, with a local frame of reference XYZ linked to the bladder, the bladder is wound around an X axis in the first configuration, the bladder is unwound around the X axis in the second configuration and the bladder is configured to have a third configuration wherein the bladder is compressed along a Y and/or Z axis so as to confer to it a third geometric shape having a third volume, the third volume being greater than or equal to the first volume and strictly less than the second volume.

Thus, when the bladder is in operation inside a fuel tank, the second configuration is a bladder rest configuration and the third configuration is a bladder working configuration. In the bladder's working configuration, the bladder is deformed by the pressure inside the fuel tank. Preferably, the bladder deformation is a compression of the bladder along the Y and/or Z axis. The bladder deformation may also be a compression of the bladder along the X axis.

The invention also provides for an assembly according to a first embodiment as aforesaid, characterized in that the assembly further comprises a device for removably retaining the bladder in the first configuration.

The removable retention device is, for example, an elastic band, a string with a knot, a U-shaped clip or similar.

This ensures effective bladder retention in the first configuration and easy bladder release.

Also provided according to the invention is an assembly according to a first embodiment as aforesaid, characterized in that the attachment device comprises a member selected from the group consisting of clipping, snap-fitting, interlocking, gluing, clamping, pinching and welding members, which member is configured to fasten the assembly to an internal fuel tank wall.

According to the invention, an assembly is also provided according to a first embodiment as aforesaid, characterized in that the assembly further comprises an anti-slosh device.

The purpose of an anti-slosh device is to attenuate the noise associated with the waves created within a fuel tank when the vehicle accelerates abruptly, brakes or goes around a curve. Such a device is also known as an anti-slosh baffle or baffle.

In one example, the anti-slosh device is made of plastic, for example polyoxymethylene (POM).

Advantageously, the anti-slosh device carries the attachment device.

Also advantageously, the anti-slosh device is provided with a handle to enable manipulation of the anti-slosh device inside the fuel tank, in particular, to secure the anti-slosh device inside the fuel tank, for example, to the bottom of the fuel tank. To this end, a complementary part of the attachment device is configured to be arranged inside the fuel tank, for example, at the bottom of the fuel tank.

Preferably, the attachment device is manufactured in one piece with the anti-slosh device. Even more preferably, the complementary part of the attachment device is welded to the bottom of the fuel tank.

Alternatively, the anti-slosh device is fitted with a spring-loaded device. In this case, the anti-slosh device is made up of two parts that can move relative to one another and are connected by the spring-loaded device. The spring-loaded device is compressed to reduce the size of the anti-slosh device and facilitate its insertion inside the fuel tank. The anti-slosh device is positioned inside the fuel tank at a predetermined location, for example, at the bottom of the fuel tank. The spring-loaded device is decompressed to bring one movable part of the anti-slosh device into abutment against a bottom wall of the fuel tank and the other movable part into abutment against a wall opposite the tank bottom wall. In the latter position, the anti-slosh device is clamped between the bottom wall of the fuel tank and the wall opposite the bottom wall of the fuel tank. This type of anti-slosh device, also known as a spring-loaded baffle, is described in document WO 2010/029103 A1.

Also provided according to the invention is an assembly according to a second embodiment comprising a bladder for a fuel tank, characterized in that the bladder is configured to have:
a first configuration wherein the bladder is compressed to give it a first geometric shape having a first volume, and
a second configuration wherein the bladder is decompressed to give it a second geometric shape with a second volume,
the first volume being strictly smaller than the second volume,
the assembly further comprising an anti-slosh device.

Thanks to the anti-slosh device, the assembly not only limits the pressure build-up of fuel vapors in the fuel tank, but also attenuates the noise associated with the waves created within a fuel tank.

Also provided according to the invention is an assembly according to a second embodiment as aforesaid, characterized in that the assembly further comprises an attachment device configured to attach the assembly to a fuel tank inner wall.

Thanks to the attachment device, the bladder does not unwind just anywhere in the fuel tank but rather in a predetermined space therein. The predetermined space is chosen so that the bladder unwinds unhindered in the fuel tank and, in the second configuration, does not interfere with the interior of the fuel tank, which could damage the bladder.

The invention also provides for an assembly according to a second embodiment as aforesaid, characterized in that the attachment device comprises a member selected from the group consisting of clipping, snap-fitting, interlocking, gluing, clamping, pinching and welding members, which member is configured to attach the assembly to an internal fuel tank wall.

Also provided according to the invention is an assembly according to a second embodiment as aforesaid, characterized in that the bladder is configured to have a third configuration wherein the bladder is compressed so as to confer thereon a third geometric shape having a third volume, the third volume being greater than or equal to the first volume and strictly less than the second volume.

Thus, when the bladder is in operation inside a fuel tank, the second configuration is a bladder rest configuration and the third configuration is a bladder working configuration. In the bladder's working configuration, the bladder is deformed by the pressure inside the fuel tank.

Also provided according to the invention is a fuel storage system for a heat engine vehicle, comprising:
a fuel tank, and
at least one assembly conforming to an aforementioned assembly extending inside the fuel tank, the fuel storage system being configured to store fuel inside the fuel tank and outside the bladder.

According to the invention, said at least one assembly extends inside the fuel tank in any configuration of the bladder, be it the first, second or third configuration.

In the case of a fuel storage system comprising at least one assembly according to the first embodiment as aforesaid, the fuel storage system is characterized in that, in the second bladder configuration, the bladder is unwound, preferably about the X axis, inside the fuel tank.

Thus, the fuel storage system for a heat engine vehicle of the prior art is here replaced by a fuel storage system for a heat engine vehicle comprising at least one assembly comprising a bladder which has had its volume reduced during its insertion and attachment inside the fuel tank. The bladder was inserted into the fuel tank through an opening in a wall of the fuel tank, which was hermetically sealed before the fuel storage system was put into operation. In one example, the aforementioned opening is a fuel tank bung hole. The assembly may combine a bladder with a device for removably holding the bladder in the first configuration and/or an anti-slosh device, said at least one assembly having had a reduced volume when inserted and attached inside the fuel tank. The at least one assembly is inserted into the fuel tank through an opening in the fuel tank wall, which is hermetically sealed before the fuel storage system is put into operation. In one example, the aforementioned opening is a fuel tank bung hole.

The term “fuel storage system for heat engine vehicles”, also known as “fuel system”, refers to any device incorporated into a heat engine vehicle, the function of which is to store, purify, measure or transport a fuel intended to supply the internal combustion engine. A fuel system comprises at least one fuel tank and a fuel supply pipe to the combustion engine. It may also include, but is not limited to, one or more of the following accessories: fuel tank vent valve and pipe, filler pipe, canister, fuel filter, fuel pump, fuel tank gauge, electrical connector, closing cap, and any other device through which liquid or gaseous fuel passes, such as a fuel vapor circulation pipe.

The fuel storage system according to the invention further comprises a ventilation pipe connecting the inside of the bladder to the outside of the fuel tank. If the bladder material is impermeable to fuel and fuel vapors, the connection outside the fuel tank opens into the atmosphere, so the fuel storage system can alternatively supply the bladder with air or evacuate some of the air contained in the bladder. If the bladder material is permeable to fuel and/or fuel vapors, the connection to the outside of the fuel tank opens out into a conduit for circulating fuel vapors to a canister, so that the fuel storage system can alternatively supply the bladder with gas or discharge some of the gas contained in the bladder to the canister. The gas fed to the bladder is either air directly from the atmosphere, or air passing through the canister.

Preferably, in the second configuration, when the fuel tank is full of fuel, the bladder is completely immersed in the fuel.

Advantageously, the fuel storage system further comprises at least one heat storage member, extending inside the fuel tank, comprising a phase-change material having a melting point between 18° and 40° C., the phase-change material being preferentially selected from the following list: calcium chloride hexahydrate (CaCl₂·6H₂O), octadecane (C₁₈H₃₈), cyclohexanol (C₆H₁₂O), a glycerin derivative.

The at least one heat storage member can absorb heat, particularly when the fuel has a temperature close to the melting point of the phase-change material. Since the fusion reaction is endothermic, it consumes heat from the fuel. The at least one heat storage member limits the temperature rise of the fuel and therefore the generation of fuel vapor in the fuel tank. This limitation of fuel vapor generation enables bladder to be sized with a smaller volume, thereby reducing the disadvantages associated with the volume of the bladder, in particular the limitation of the useful tank volume. This means that the combined effects of the at least one heat storage member and the bladder outweigh the effects of the at least one heat storage member and the bladder on their own.

Advantageously, in the third bladder configuration, the bladder of a fuel storage system comprising an assembly according to the first embodiment as aforesaid is compressed along the Y and/or Z axis inside the fuel tank.

This limits pressure build-up inside the fuel tank by allowing fuel vapors to occupy excess volume inside the fuel tank. The excess volume is supplied by the bladder, in the third bladder configuration.

In addition, compressing the bladder along the Y and/or Z axis inside the fuel tank enables the bladder volume to be reduced more effectively. Indeed, when the largest dimension of the bladder extends along the X axis, compressing the bladder wall along the Y and/or Z axis offers less resistance to deformation than compressing the bladder along the X axis.

The invention also provides for the use of at least one assembly, conforming to an aforementioned assembly, in a fuel tank, the bladder being designed to limit the increase in pressure inside the fuel tank, in order to limit mechanical stresses on the fuel tank.

Also provided according to the invention is a kit for manufacturing a fuel storage system for a heat engine vehicle, the system comprising a fuel tank and at least one anti-slosh device extending inside the fuel tank, the kit being characterized in that it comprises at least one assembly, conforming to an aforementioned assembly, the bladder being carried by the at least one anti-slosh device.

In this way, a fuel tank equipped with at least one anti-slosh device can easily be converted into a fuel tank equipped with at least one anti-slosh device carrying a bladder of an assembly according to the invention.

The invention also provides for a heat engine vehicle comprising a fuel storage system conforming to one of the aforementioned systems.

A method of manufacturing a fuel storage system for a heat engine vehicle is also provided, comprising the following steps:
a) manufacturing a fuel tank,
b) manufacturing a bladder conforming to the above-mentioned bladder,
c) maintaining the bladder in the first configuration,
d) inserting the bladder into the fuel tank through an opening in the fuel tank wall,
e) attaching the bladder inside the fuel tank so that the bladder extends inside the fuel tank,
f) releasing the bladder from the first configuration to the second configuration so that, in the second configuration, the bladder is unwound, preferably about the X axis, inside the fuel tank.

In one example, step d) of inserting the bladder into the fuel tank through an opening in a fuel tank wall is performed manually by an operator.

In a preferred embodiment, the unwound shape of the bladder is the initial shape of said bladder, that is, its shape at the end of manufacturing. Moreover, by manufacturing said bladder from an elastic material, a deformation thereof, for example by winding said bladder in on itself, becomes reversible. In this case, switching from the first configuration to the second configuration is automatic. In fact, after releasing said bladder in step f), that is, after removing the mechanical constraint that obliged said bladder to remain wound in on itself, the bladder unwinds by itself to completely or almost completely regain its initial shape. In the event that said bladder almost completely regains its initial shape, it can be helped to completely regain its initial shape by sending a pressurized gas into said bladder, for example pressurized air.

Advantageously, in the aforementioned method, step e) of attaching the bladder inside the fuel tank is carried out by clipping, snap-fitting, interlocking, gluing, clamping, pinching or welding the bladder to an internal wall of the fuel tank.

Preferably, the inner wall of the fuel tank is a bottom wall of the fuel tank.

Advantageously, in the aforementioned process, step c) of maintaining the bladder in the first configuration is carried out by means of a removable retention device.

Also provided according to the invention is a method of manufacturing a fuel storage system for a heat engine vehicle, comprising the following steps:
a) manufacturing a fuel tank,
b) manufacturing at least one assembly conforming to one of the above-mentioned assemblies,
c) maintaining the bladder in the first configuration,
d) inserting the at least one assembly into the fuel tank through an opening in a fuel tank wall,
e) attaching the at least one assembly inside the fuel tank so that the at least one assembly extends inside the fuel tank,
f) releasing the bladder from the first configuration to the second configuration inside the fuel tank.

In one example, step d) of inserting the at least one assembly into the fuel tank through an opening in a fuel tank wall is performed manually by an operator.

In the case of a fuel storage system comprising at least one assembly according to the first embodiment as aforesaid, step f) of releasing the bladder from the first configuration to the second configuration is carried out in such a way that, in the second configuration, the bladder is unwound, preferably about an axis X, inside the fuel tank.

In a preferred embodiment, the unwound shape of the bladder is the initial shape of the bladder, that is, its shape at the end of manufacture. Moreover, by manufacturing said bladder from an elastic material, a deformation thereof, for example by winding said bladder in on itself, becomes reversible. In this case, switching from the first configuration to the second configuration is automatic. In fact, after releasing said bladder in step f), that is, after removing the mechanical constraint that obliged said bladder to remain wound in on itself, the bladder unwinds by itself to completely or almost completely regain its initial shape. In the event that said bladder almost completely regains its initial shape, it can be helped to completely regain its initial shape by sending a pressurized gas into said bladder, for example pressurized air.

Advantageously, in the aforementioned process, step e) of attaching the at least one assembly inside the fuel tank is carried out by clipping, snap-fitting, interlocking, gluing, clamping, pinching or welding the at least one assembly to an internal wall of the fuel tank.

Preferably, the inner wall of the fuel tank is a bottom wall of the fuel tank.

Preferably, in the case of clamping the at least one assembly to a fuel tank bottom wall, said clamping is achieved by means of a spring-loaded device as previously described, such that said at least one assembly is clamped between the fuel tank bottom wall and a wall opposite the fuel tank bottom wall.

Advantageously, in the aforementioned process, step c) of maintaining the bladder in the first configuration is carried out by means of a removable retention device.

Also provided according to the invention is a fuel storage system for heat engine vehicles, characterized in that it is obtained by implementing the aforementioned manufacturing process.

Finally, the invention provides a method of operating a fuel storage system in accordance with one of the above-mentioned systems, characterized in that the method comprises, in response to an increase in pressure inside the fuel tank, a step of deforming the bladder in order to switch from the second configuration to the third configuration.

The step of deforming the bladder from the second configuration to the third configuration is achieved solely by increasing the pressure inside the fuel tank.

### BRIEF DESCRIPTION OF THE DRAWINGS

Other features and advantages of the invention will become apparent from the description given below, by way of indication and in no way limiting, with reference to the accompanying drawings, wherein:

FIG. 1 is an exploded perspective view of the main components of a fuel storage system according to the invention, wherein the bladder is shown in the second configuration;

FIG. 2 is a view similar to FIG. 1, wherein the bladder is shown in the first configuration;

FIG. 3 is a view similar to FIG. 2 wherein the bladder is shown at the beginning of its coupling to the fuel tank;

FIGS. 4 to 13 are T-plane cross-sections of the fuel tank shown in FIG. 3, wherein the bladder is shown in various successive positions of coupling to the fuel tank;

FIG. 14 is a perspective view of a heat engine vehicle according to the invention.

### DETAILED DESCRIPTION OF AT LEAST ONE EMBODIMENT OF THE INVENTION

In the various figures, identical or similar elements bear the same references, optionally with an index added. The description of their structure and their function is therefore not always repeated.

In the following, the orientations are the orientations of the figures. In particular, the terms “upper”, “lower”, “left”, “right”, “above”, “below”, “forward” and “backward” are generally understood relative to the direction of representation of the figures.

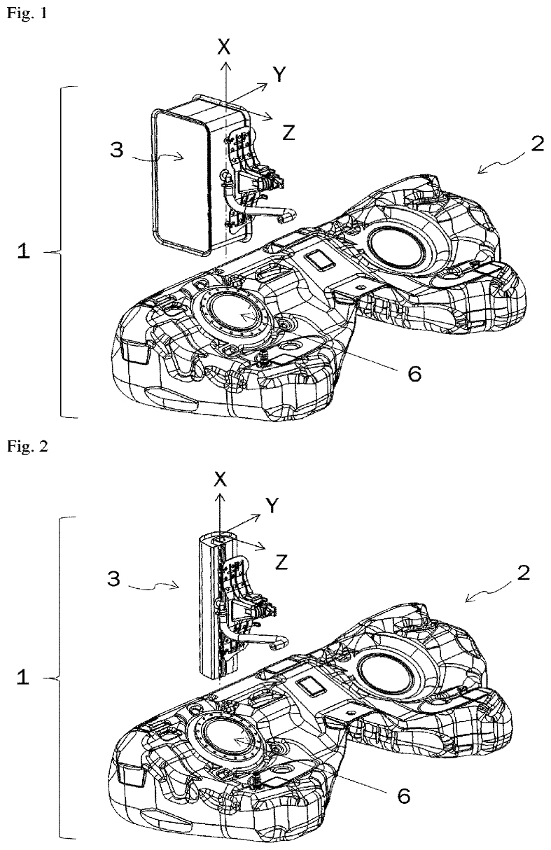

FIGS. 1 and 2 illustrate the main components of a fuel storage system 1 according to the invention.

The main components of the fuel storage system 1 include a fuel tank 2 and a bladder 3.

The fuel tank 2, generally made of plastic, is configured to store the fuel used by the heat engine vehicle, in particular for its propulsion, inside the fuel tank 2 and outside the bladder 3. The fuel tank 2 comprises a wall delimiting a hollow body defining an interior volume wherein the fuel is stored in both liquid and gaseous form, according to a distribution that depends in particular on the pressure and temperature conditions inside the tank 2. The fuel tank generally comprises a filler pipe for filling the tank with fuel, a vent pipe for evacuating fuel vapors under certain conditions, and an injection pipe for delivering fuel to the engine of the heat engine vehicle. These three pipes are well known to the prior art, so they are not shown on the figures and will not be described further in the following.

The bladder 3 has an elastically deformable wall allowing it to be wound and unwound without plastic deformation. In this case, the bladder is made from an elastic material, that is, a flexible, deformable material that returns to its initial shape when it is no longer mechanically constrained. In one example, the bladder is manufactured from a thermoplastic elastomer material, such as thermoplastic polyurethane (TPU).

In another example, the bladder is manufactured from polyethylene (PE), polyamide (PA), or in the form of a multilayer comprising polyethylene (PE) and ethylene vinyl alcohol (EVOH). Preferentially, the polyethylene is high-density polyethylene (HDPE), the polyamide is polyamide 6, 11 or 12 (PA6, PA11 or PA12), and the multilayer comprises an adhesive layer between a high-density polyethylene layer and the ethylene vinyl alcohol layer. Advantageously, the multilayer comprises an adhesive layer between the polyethylene (PE) layer, preferentially high-density polyethylene (HDPE), and the ethylene vinyl alcohol (EVOH) layer.

According to the invention, bladder 3 is configured to have a first configuration and a second configuration. In the first configuration, the bladder 3 is wound in on itself about an axis X so as to give the bladder 3 a first geometric shape with a first volume (see FIG. 2). In the example shown, the first geometric shape is generally cylindrical. In the second configuration, the bladder 3 is unwound about the X axis to give the bladder 3 a second geometric shape with a second volume (see FIG. 1). In the example shown, the second geometric shape is generally prismatic. Alternatively, the second geometric shape is generally cylindrical or spherical (not shown). In every case, the first volume is strictly smaller than the second volume.

In practice, the second volume is proportional to the volume of fuel in the fuel tank 2. Advantageously, the second volume is between 20% and 50% of the volume of fuel wherein the bladder 3 is immersed, preferably the second volume is between 20% and 30% of the volume of fuel wherein the bladder 3 is immersed.

The maximum volume of the bladder 3 is chosen according to the volume and shape of the fuel tank 2, and the range of values proposed can be adapted to certain types of motor vehicle tanks.

The X axis is part of an XYZ local coordinate system linked to bladder 3. The bladder 3 is configured to have a third configuration. In the third configuration, the bladder 3 is compressed along the Y and/or Z axis to confer thereon a third geometric shape with a third volume (not shown). The third volume is greater than or equal to the first volume and strictly less than the second volume.

In FIGS. 1 and 2, the bladder 3 is not yet coupled to the fuel tank 2.

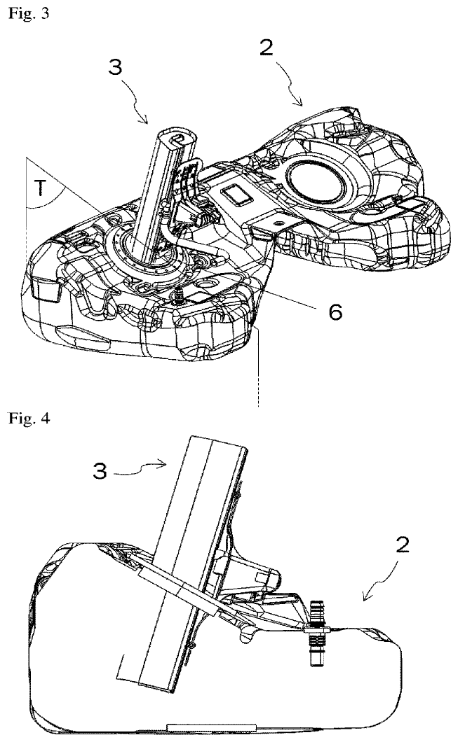

FIG. 3 shows the start of the insertion of the bladder 3 into the fuel tank 2 through an opening 6, that is, the start of its coupling to the fuel tank 2. Opening 6 is a fuel tank bung hole.

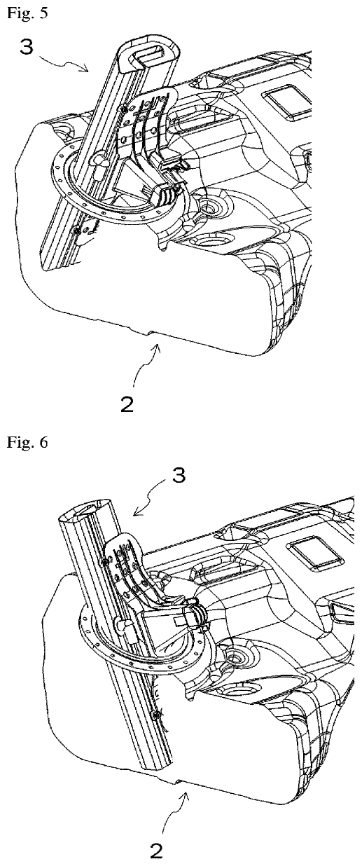

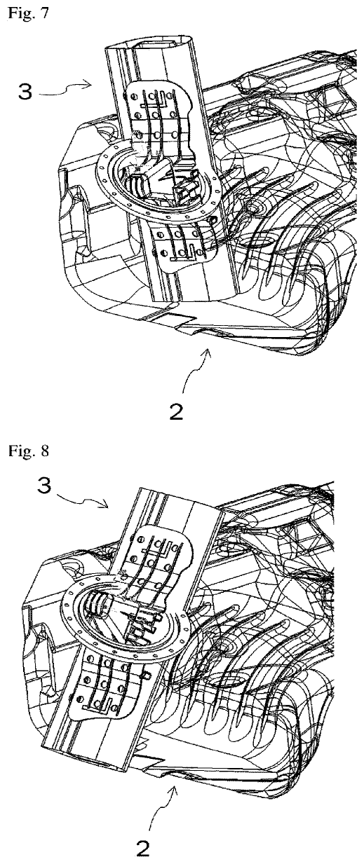

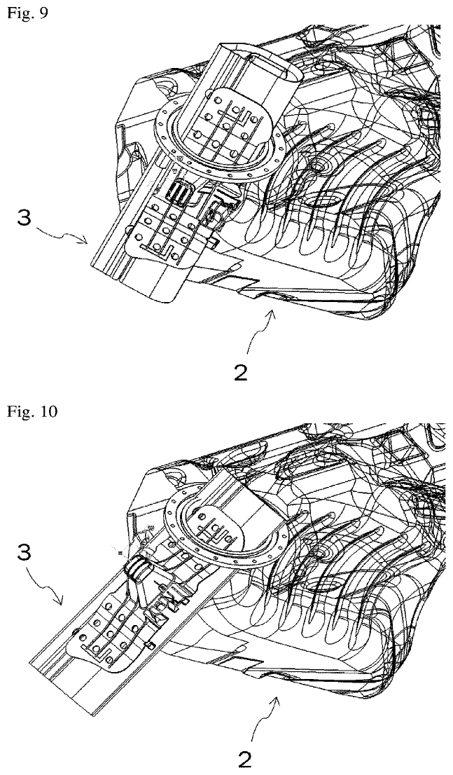

FIGS. 4 to 13 show various successive positions of the bladder 3 in the fuel tank 2 up to the final position, that is, the position wherein coupling of the bladder 3 to the fuel tank 2 is complete.

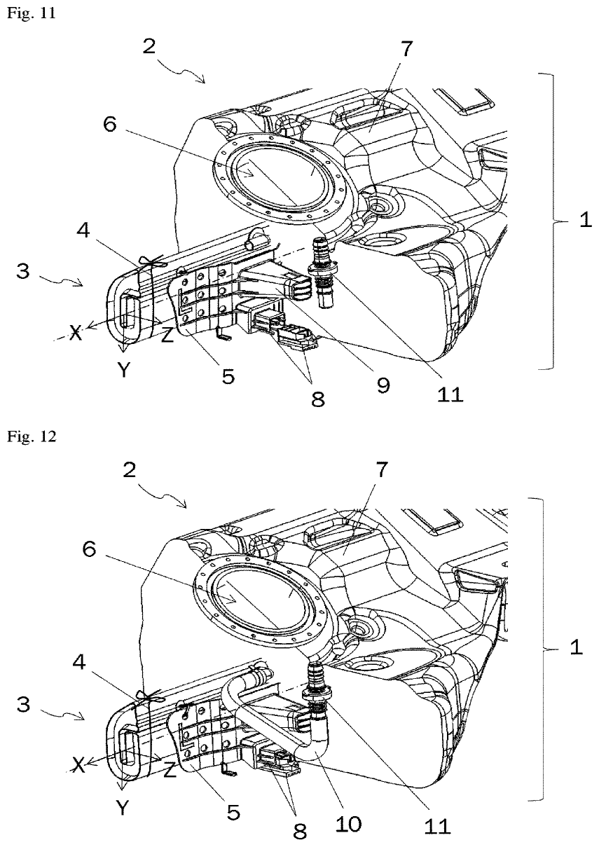

As shown in FIGS. 11 and 12, the bladder 3 is part of an assembly further comprising an attachment device configured to attach the assembly to an inner wall of the fuel tank 2. The attachment device comprises a member selected from the group consisting of clipping, snap-fitting, interlocking, gluing, clamping, pinching and welding members, configured to attach the assembly to an internal fuel tank wall 2. The assembly also includes a removable retention device 4 for the bladder 3 in the first configuration, in this case a string with a knot, and an anti-slosh device 5 carrying the bladder 3. In one example, the anti-slosh device 5 is made of plastic, such as polyoxymethylene (POM).

As an alternative to string with a knot, the removable retention device 4 is an elastic band or a clip, for example, a U-shaped clip (not shown).

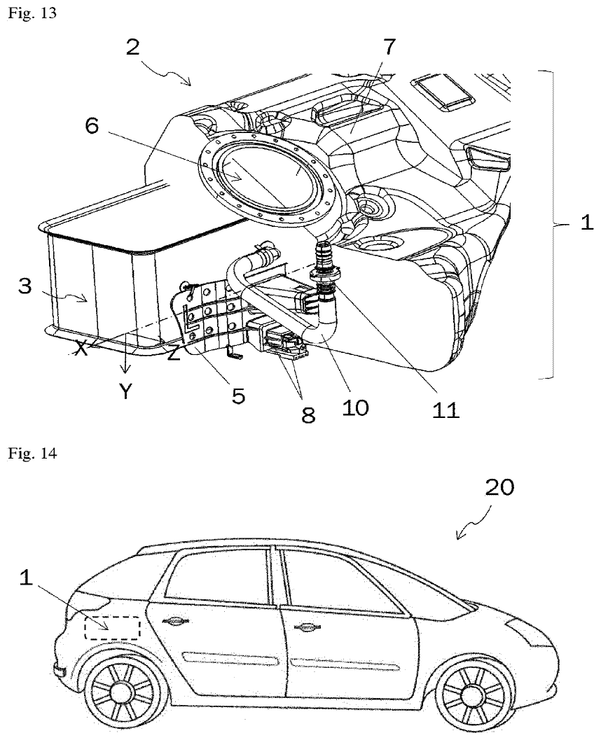

FIGS. 1 to 13 also show steps in a method for manufacturing a fuel storage system 1 for a heat engine vehicle comprising the above assembly. The method comprises the following steps:
a) manufacturing a fuel tank 2 (FIG. 1 shows fuel tank 2 as manufactured),
b) manufacturing the above-mentioned assembly (FIG. 1 shows the above-mentioned assembly as manufactured),
c) retaining the bladder 3 in the first configuration (FIG. 2 shows the above assembly wherein the bladder 3 is retained in the first configuration),
d) inserting the assembly into the fuel tank 2 (FIGS. 3 to 11 illustrate different stages of insertion into the fuel tank 2 of the aforementioned assembly wherein the bladder 3 is retained in the first configuration), the insertion of the aforementioned assembly being carried out through the opening 6 made in a wall 7 of the fuel tank 2 (see FIG. 11),
e) attaching the assembly inside the fuel tank 2 so that the assembly extends inside the fuel tank 2 (FIG. 12 shows the above-mentioned assembly in the attached position),
f) releasing the bladder 3 from the first configuration to the second configuration so that, in the second configuration, the bladder 3 is unwound around the X axis inside the fuel tank 2 (FIG. 13 shows the bladder unwound around the X axis inside the fuel tank 2).

Material interferences between the aforementioned assembly and the opening 6 are visible in FIGS. 3 to 10. These interferences are due to the fact that the bending deformation of the assembly is not shown in these figures. In the fuel tank 2 shown, the opening 6 must be bent for the aforementioned assembly to pass through.

Step c) of retaining the bladder 3 in the first configuration is carried out by means of a removable retention device 4, in this case a string with a knot.

Step e) of attaching the assembly inside the fuel tank 2 is carried out by means of a device for attaching the assembly to an internal wall of the fuel tank 2, in this case comprising a clipping member 8 (FIG. 11 shows the assembly before clipping, while FIG. 12 shows the assembly after clipping).

In the example shown, clip member 8 is a female part of a clip. The female part of the clip is carried by the anti-slosh device 5, which also includes a handle 9 to facilitate handling of the anti-slosh device 5 inside the fuel tank 2, in particular, for clipping the anti-slosh device 5 to the bottom of the fuel tank 2. To this end, the male part of the clip is arranged at the bottom of the fuel tank 2. Preferably, the female part of the clip is made in one piece with the anti-slosh device 5 and the male part of the clip is welded to the bottom of the fuel tank 2.

As an alternative to the attachment device comprising the clipping member 8, the assembly is attached inside the fuel tank 2 by means of an attachment device comprising a member for snap-fitting, interlocking, gluing, clamping, gripping or welding the assembly to an internal wall of the fuel tank 2 (means not shown).

Step f) releasing the bladder 3 by untying the string.

FIG. 13 shows a fuel storage system 1 for a heat engine vehicle obtained by implementing the aforementioned manufacturing method, comprising a fuel tank 2 and the aforementioned assembly. This assembly extends inside the fuel tank 2. In the second configuration, bladder 3 is unwound around axis X inside fuel tank 2. In the third configuration, the bladder 3 is compressed along the Y and/or Z axis inside the fuel tank 2 (configuration not shown).

The use of the bladder 3 in the fuel tank 2 of the fuel storage system 1 for a heat engine vehicle serves to limit the increase in pressure inside the fuel tank 2.

In fact, when the temperature of the fuel contained in the fuel tank 2 rises, for example when the outside temperature exceeds the fuel temperature, some of the fuel evaporates, which generates fuel vapors in the fuel tank 2. Since the fuel tank 2 defines a closed and sealed volume, increasing the amount of fuel vapor increases the pressure in the gas phase inside the fuel tank 2. It will now be described how the fuel storage system 1 according to the invention makes it possible to limit this pressure increase.

The bladder 3 is compressed under the action of the pressure in the gaseous phase inside the tank 2. As the wall of the bladder 3 is deformable, an equilibrium of stresses on the wall of the bladder 3 is established, leading to the evacuation of all or part of the air contained in the bladder 3 by means of a ventilation pipe 10. The ventilation pipe 10 is connected, on the one hand, to the bladder 3, more precisely, to the inner volume of the bladder 3 via a first connection of the ventilation pipe 10, and, on the other hand, to the outside of the fuel tank 2 via a second connection 11 of the ventilation pipe 10. In this way, the volume of the bladder 3 extending into the fuel tank 2 decreases, and the volume occupied by the fuel vapors increases, resulting in a reduction in fuel vapors pressure. When the fuel temperature eventually drops, for example when the outside temperature falls below the fuel temperature, some of the fuel vapor condenses. This reduces the amount of fuel vapor in the fuel tank 2, as well as the pressure of the fuel vapors. A new equilibrium of stresses on the bladder wall 3 is established, leading to a filling of bladder 3 through the ventilation pipe 10 and an increase in the volume of bladder 3 extending into the fuel tank 2. Although the ventilation pipe 10 is not shown in all figures, it is connected to the bladder 3 before the bladder 3 is inserted inside the fuel tank 2. The ventilation pipe 10 is made of a flexible material that allows it to be deformed with the bladder 3 as it is inserted into the fuel tank 2.

Thus, when the bladder 3 is in operation inside the fuel tank 2, the bladder 3 deforms in response to an increase in pressure inside the fuel tank 2 causing the bladder 3 to change from the second to the third configuration. The aforementioned deformation is part of a method for operating the aforementioned fuel storage system 1.

In an alternative embodiment (not shown), the aforementioned assembly is replaced by the bladder 3 alone. In another alternative embodiment (not shown), the bladder 3 is coupled to one and/or other of the removable retention device 4 and the anti-slosh device 5.

Finally, FIGS. 1 to 13 illustrate a kit for manufacturing a fuel storage system 1 for a heat engine vehicle. The fuel storage system 1 for a heat engine vehicle comprises a fuel tank 2 and an anti-slosh device 5 extending inside the fuel tank 2. The kit comprises the above-mentioned assembly, with the bladder 3 carried by the anti-slosh device 5.

FIG. 14 shows an internal combustion engine vehicle 20 comprising the above-mentioned fuel storage system 1.

### LIST OF REFERENCES

1: fuel storage system
2: fuel tank
3: bladder
4: removable retention device
5: anti-slosh device
6: opening
7: wall
8: clipping
9: handle
10: ventilation pipe
11: ventilation pipe connection
20: vehicle

1-17. (canceled)

18. An assembly comprising:
a bladder for a fuel tank, the bladder being is configured to have:
a first configuration wherein the bladder is compressed to confer thereon a first geometric shape having a first volume, and
a second configuration wherein the bladder is decompressed to confer thereof a second geometric shape with a second volume,
the first volume being strictly smaller than the second volume; and
an anti-slosh device.

19. The assembly according to claim 18, further comprising an attachment device configured to attach the assembly to an inner wall of a fuel tank.

20. The assembly according to claim 19, wherein the attachment device comprises a member selected from the group consisting of clipping, snap-fitting, interlocking, gluing, clamping, pinching and welding members, and the member is configured to attach the assembly to an inner wall of a fuel tank.

21. The assembly according to claim 18, wherein the bladder is configured to have a third configuration wherein the bladder is compressed so as to confer thereon a third geometric shape having a third volume, the third volume being greater than or equal to the first volume and strictly less than the second volume.

22. The assembly according to claim 18, wherein the fuel tank is part of a fuel storage system for a heat engine vehicle, the bladder being configured to limit an increase in pressure inside the fuel tank.

23. A fuel storage system for a heat engine vehicle, comprising:
the fuel tank; and
the assembly according to claim 18, wherein the assembly extends inside the fuel tank, the fuel storage system being configured to store fuel inside the fuel tank and outside the bladder.

24. The fuel storage system according to claim 22, further comprising a ventilation pipe connecting an inside of the bladder to an outside of the fuel tank.

25. A kit for manufacturing a fuel storage system for a heat engine vehicle, the system comprising the fuel tank and the anti-slosh device extending inside the fuel tank, the kit comprising:
the assembly according claim 18,
wherein the bladder is carried by the anti-slosh device.

26. The heat engine vehicle comprising the fuel storage system according to claim 23.

27. A method of manufacturing a fuel storage system for a heat engine vehicle, comprising:
a) manufacturing the fuel tank;
b) manufacturing the assembly according to claim 18;
c) maintaining the bladder in the first configuration;
d) inserting the assembly inside the fuel tank through an opening in a wall of the fuel tank;
e) attaching the assembly inside the fuel tank so that the assembly extends inside the fuel tank; and
f) releasing the bladder to switch from the first configuration to the second configuration inside the fuel tank.

28. The method according to claim 27, wherein step e) of attaching the assembly inside the fuel tank is carried out via clipping, snap-fitting, interlocking, gluing, clamping, pinching, or welding the assembly to an inner wall of the fuel tank.

29. The method according to claim 27, wherein step c) of maintaining the bladder in the first configuration is carried out via a removable retention device.

30. The fuel storage system for the heat engine vehicle, wherein the fuel storage system is obtained by the method according to claim 27.
